(19) United States
(12) Patent Application Publication
(10) Pub. No.: US 2010/0003984 A1
(43) Pub. Date: Jan. 7, 2010

(54) METHOD AND APPARATUS FOR SUPPORTING DUAL TRANSFER MODE FOR HANDOVER IN GSM SYSTEM

(75) Inventors: Gwan-Gyu SEO, Suwon-si (KR); Yu-Shin KIM, Osan-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/491,871

(22) Filed: Jun. 25, 2009

(30) Foreign Application Priority Data
Jul. 1, 2008 (KR) 10-2008-0063351

(51) Int. Cl. H04W 36/00

(52) U.S. Cl. 455/436

(57) ABSTRACT

A method for operating a Mobile Station (MS) for maintaining a Dual Transfer Mode (DTM) and apparatus for supporting the DTM for a handover process in a Global System for Mobile Communications (GSM) system are provided. The method includes receiving a broadcast control message from at least one neighbor cell, determining whether the at least one neighbor cell supports the DTM by using the broadcast control message, and reporting the determination result on whether the DTM is supported and a received signal measurement result. Accordingly, a DTM service can be seamlessly maintained.

### PRIORITY

This application claims the benefit under 35 U.S.C. § 119(a) of a Korean patent application filed in the Korean Intellectual Property Office on Jul. 1, 2008 and assigned Serial No. 10-2008-0063351, the entire disclosure of which is hereby incorporated by reference.

### BACKGROUND OF THE INVENTION

1. Field of the Invention

The present invention relates to a Global System for Mobile Communications (GSM) system. More particularly, the present invention relates to a method and apparatus for maintaining a Dual Transfer Mode (DTM) during performance of a handover.

2. Description of the Related Art

A Global System for Mobile Communications (GSM) system classifies a Mobile Station (MS) into three classes (A, B, and C) according to access to a Circuit Switched (CS) network, a Packet Switched (PS) network and a Core Network (CN) network.

First, in class A, the GSM system supports both PS service and CS service, and the PS service and CS service are simultaneously provided. That is, the class A allows the PS service to be used while providing the CS service, which is referred to as a Dual Transfer Mode (DTM).

Second, in class B, the GSM system supports both the PS service and CS service, and only one of the PS service and CS service is provided instead of simultaneously providing them.

Third, in class C, the GSM system provides only one of the PS service and CS service. Herein, the PS service is a service for providing Internet browsing or text services for the use of a mobile terminal, and the CS service is a general voice service.

In a conventional technique, the GSM system supports a CS service link-based handover (i.e., hard handover), and also supports a PS service link-based handover. However, a handover process for the DTM is not proposed in detail. That is, in the DTM, if a handover occurs under the CS link, the PS link is released and a CS handover is performed by using the same method performed in a dedication mode. Then, after performing the CS handover, the CS link is established to a new Base Station (BS). Meanwhile, even if only the CS link is released in the DTM, the PS link is also released, and mode transition is made from an idle mode to a packet transfer mode.

FIG. 1 illustrates a wireless environment in which an MS supporting a DTM moves from a serving BS to another neighbor BS in a conventional GSM system.

Referring to FIG. 1, a plurality of cells are present in a wireless environment in which cells 100, 120 and 130 support a DTM service, and a cell 110 does not support the DTM service. In this environment, an MS 112 receives the DTM service in the cell 100. In this case, if the MS 112 moves to the cell 110 that does not support the DTM service, the DTM service cannot be maintained because the cell 110 does not support the DTM service.

As described above, a conventional method does not consider the DTM when measurement is performed on a neighbor cell for a handover process. Therefore, when the MS 112 moves to the cell 110 not supporting the DTM while a packet service is being provided using the DTM, the MS 112 cannot seamlessly maintain the packet service.

Therefore, a need exists for a method and apparatus for seamlessly receiving a packet service by maintaining a DTM service during a handover process in a GSM system.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for supporting a Dual Transfer Mode (DTM) service during a handover process in a Global System for Mobile Communications (GSM) system.

Another aspect of the present invention is to provide a method and apparatus for seamlessly maintaining packet services by supporting a DTM service during a handover process in a GSM system.

In accordance with an aspect of the present invention, a method for operating a Mobile Station (MS) for maintaining a DTM during a handover process in a GSM system is provided. The method includes receiving a broadcast control message from at least one neighbor cell, determining whether the at least one neighbor cell supports the DTM by using the broadcast control message, and reporting the determination result on whether the DTM is supported and a received signal measurement result.

In accordance with another aspect of the present invention, a method for operating a Base Station (BS) for maintaining a DTM during performance of a handover in a GSM system is provided. The method includes receiving information indicating whether the DTM is supported and a measurement result from a corresponding MS, determining whether neighbor cells of the corresponding MS support the DTM by using the measurement result, and determining a target BS for the handover process by considering whether the neighbor cells support the DTM.

In accordance with still another aspect of the present invention, an MS apparatus for maintaining a DTM during performance of a handover in a GSM system is provided. The apparatus includes a Radio Frequency (RF) unit for receiving a broadcast control message from at least one neighbor cell, and a controller for determining whether the at least one neighbor cell supports the DTM by using the broadcast control message, and for reporting the determination result on whether the DTM is supported and a received signal measurement result.

In accordance with a further aspect of the present invention, a BS apparatus for maintaining a DTM during performance of a handover in a GSM system is provided. The apparatus includes a transmitter for receiving a measurement result from a corresponding MS, a DTM evaluator for determining whether neighbor cells support the DTM by using the measurement result, and a handover manager for determining a target BS for the handover process by considering whether the neighbor cells support the DTM.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a wireless environment in which a Mobile Station (MS) supporting a Dual Transfer Mode (DTM) moves from a serving Base Station (BS) to a neighboring BS in a conventional Global System for Mobile Communications (GSM) system;

FIG. 2 illustrates a flowchart for an operation of an MS for maintaining a DTM during performance of a handover in a GSM system according to an exemplary embodiment of the present invention;

FIG. 3 illustrates a flowchart for an operation of a BS for maintaining a DTM during performance of a handover in a GSM system according to an exemplary embodiment of the present invention;

FIG. 4 illustrates a measurement results message format for reporting to a BS according to an exemplary embodiment of the present invention;

FIG. 5 illustrates a block diagram for a structure of an MS for maintaining a DTM during performance of a handover in a GSM system according to an exemplary embodiment of the present invention; and

FIG. 6 illustrates a block diagram for a structure of a BS for maintaining a DTM during performance of a handover in a GSM system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Hereinafter, a method and apparatus for maintaining a Dual Transfer Mode (DTM) during a handover process in a Global System for Mobile Communications (GSM) system are described.

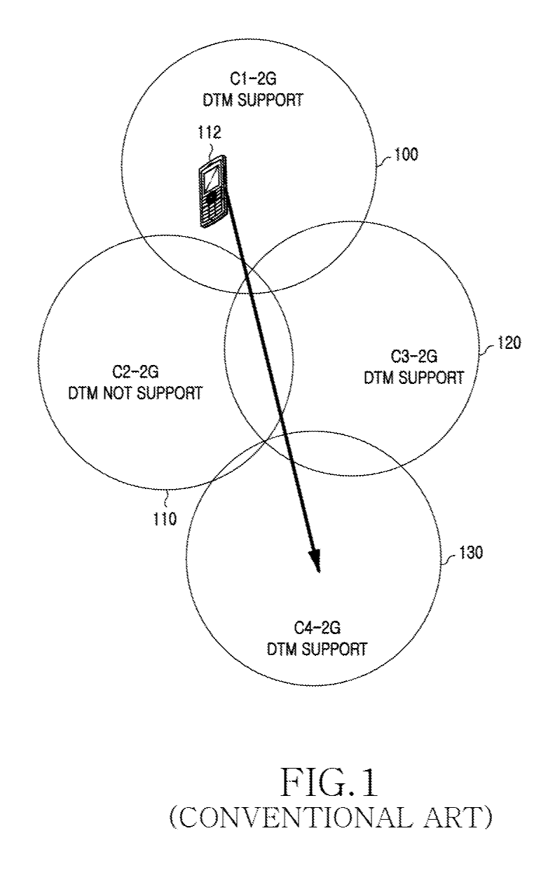

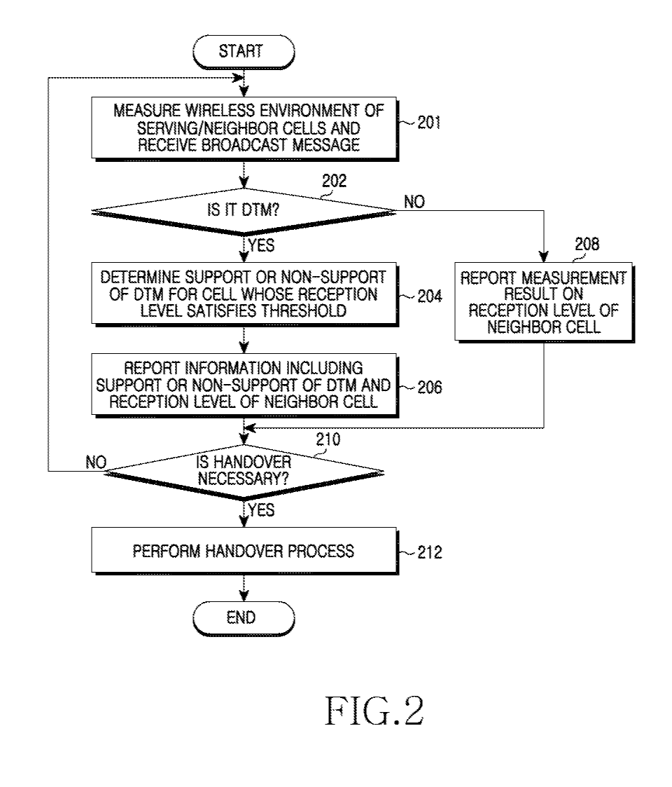

FIG. 2 illustrates a flowchart for an operation of a Mobile Station (MS) for maintaining a DTM during performance of a handover in a GSM system according to an exemplary embodiment of the present invention. It is assumed herein that, as illustrated in FIG. 1, an MS 112 is currently performing a DTM service and is moving from a 1st cell 100 to a 4th cell 130.

Referring to FIG. 2, in step 201, the MS 112 measures a wireless environment of the serving cell 100 and the neighbor cells 110, 120 and 130, and receives corresponding broadcast control messages. The MS 112 measures a Receive (Rx) signal level by measuring the wireless environment, and receives the broadcast control messages which are broadcast in periods from the neighbor cells. System Information (SI) included in the broadcast control messages differs according to the SI types. For example, an SI type 1 includes Random Access CHannel (RACH) control information and cell allocation information, an SI type 2 includes RACH control information and neighbor cells' Broadcast Control CHannel (BCCH) allocation control information, and an SI type 3 includes RACH control information, a location area identification, a cell identity, and a variety of information on cells. More particularly, an SI type 3 includes DTM_SUPPORT to report whether the DTM is supported.

If it is determined that a current mode is the DTM in step 202, the MS 112 determines whether the neighbor cells support the DTM by using a control message (e.g., SI type 3) broadcast from the neighbor cells 110, 120 and 130 in step 204. In other words, the MS may decode the SI type 3 of neighbor cells included in a BCCH Allocation (BA) list to determine whether the DTM is supported. The BA list is a list of frequencies supported by the neighbor cells.

Otherwise, if it is determined that the current mode is not the DTM in step 202, the MS 112 reports information to a BS in step 208. The information includes a reception level of the neighbor cells and does not include information indicating whether the DTM is supported.

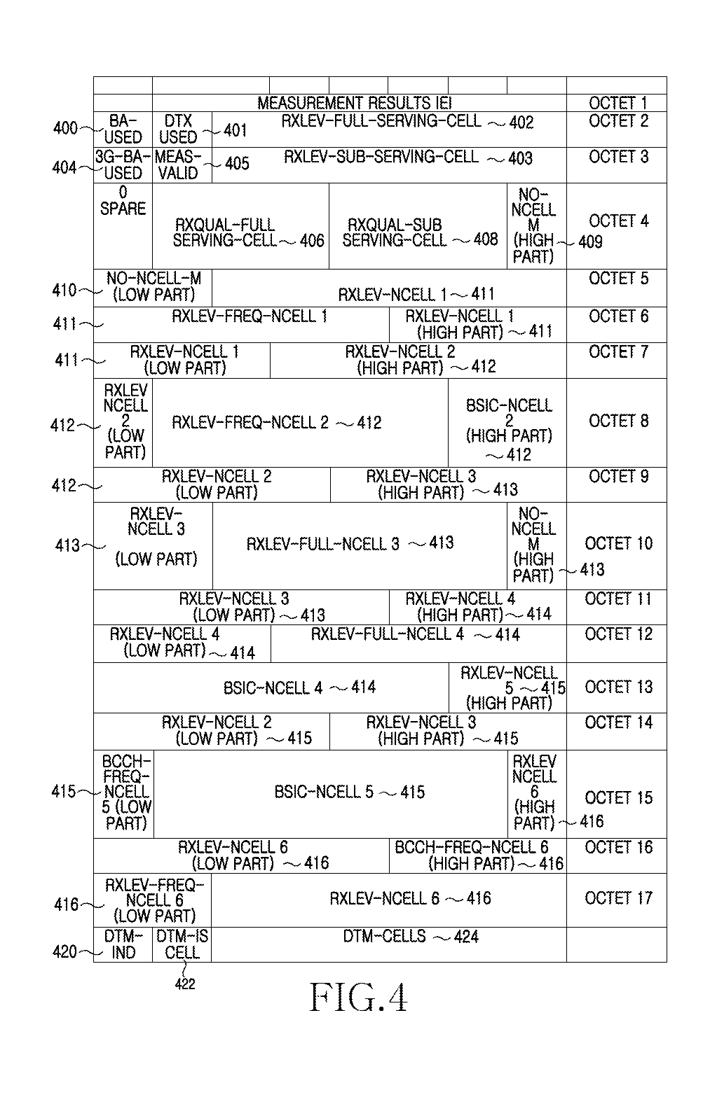

In step 206, the MS 112 stores/maintains the result of determining whether the DTM is supported, and reports the information indicating whether the DTM is supported and the information including the reception level of the neighbor cells to the BS. Information on measurement results is reported to the BS as illustrated in FIG. 4.

FIG. 4 illustrates a measurements results message format for reporting to a BS according to an exemplary embodiment of the present invention.

Referring to FIG. 4, the information includes BA-USED 400, DTX_USED 401, 3G-BA-USED 404, MEAS-VALID 405, RXLEV-FULL-SERVING-CELL 402, RXLEV-SUB-SERVING-CELL 403, RXQUAL-FULL-SERVING-CELL 406, RXQUAL-SUB-SERVING-CELL 408, NO-NCELL-M 409 and 410, RXLEV_NCELL-1 411, BCCH-FREQ-NCELL-1 411, BSIC-NCELL-1 411, and the like. Herein, the BSIC-NCELL-1 411 includes not only information on a cell 1 but also information 412 on a cell 2, information 413 of a cell 3, information 414 on a cell 4, information 415 on a cell 5, information 416 on a cell 6, and the like. A currently available standard provides information on these 6 cells.

The BA-USED 400 is a BA_IND field value of a neighbor cell description information element. The DTX_USED 401 is a bit indicating existence of an MS using Discontinuous Transmission (DTX). The 3G-BA-USED 404 is a 3G-BA_IND field value of the neighbor cell description information element. The MEAS-VALID 405 is a bit indicating validity of a measurement result value for a dedicated channel. The RXLEV-FULL-SERVING-CELL 402 is received signal strength measured for a serving cell with respect to all slots. The RXLEV-SUB-SERVING-CELL 403 is received signal strength measured for the serving cell with respect to subsets of a slot. The RXQUAL-FULL-SERVING-CELL 406 is received signal quality measured for the serving cell with respect to all slots. The RXQUAL-SUB-SERVING-CELL 408 is received signal quality measured for the serving cell with respect to subsets of a slot. The NO-NCELL-M 409 and 410 is the number of neighbor cells to be measured. The RXLEV_NCELL-1 411 is received signal strength for a neighbor cell 1. The BCCH-FREQ-NCELL-1 411 is a BCCH subcarrier of the neighbor cell 1. The BSIC-NCELL-1 411 is a BS identification code of the neighbor cell 1.

In addition thereto, DTM-IND 420, DTM-IS-CELL 422 and DTM-CELLS 424 are also reported by being added to the measurement result information. The DTM-IND 420 indicates whether a measurement result is for the DTM. The DTM-IS-CELL 422 indicates existence of cells supporting the DTM. The DTM-CELLS 424 indicates whether the DTM is supported by using a bitmap with respect to the 6 cells.

When managing a result of determining whether the DTM is supported, the MS 112 may manage the result by examining support or non-support of the DTM with respect to all neighbor cells, and may optionally manage the result by examining support or non-support of the DTM for a neighbor cell of which measured received signal strength satisfies a threshold.

Referring again to FIG. 2, if it is determined that a handover is necessary in step 210, the MS 112 performs the handover process in step 212. Thus, the MS 112 is handed over to a target cell determined by the BS. Otherwise, if it is determined that the handover is unnecessary in step 210, steps 201 to step 208 are repeated. That is, the MS 112 periodically reports the measurement result to the serving cell until the MS 112 is handed over.

In an exemplary implementation, the MS 112 may select the target cell first and then report the selected target cell to the serving BS.

Thereafter, the procedure of FIG. 2 ends.

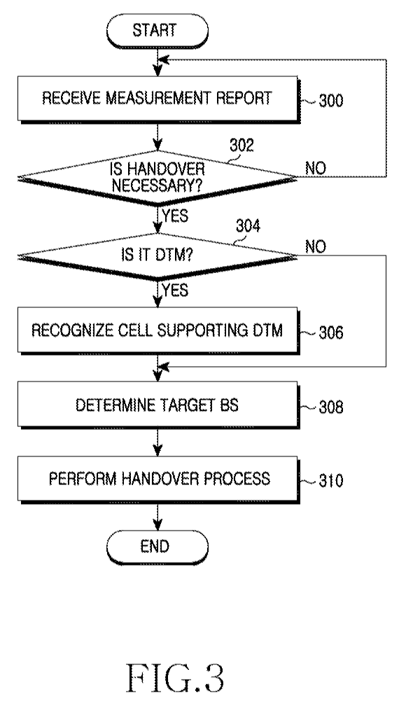

FIG. 3 illustrates a flowchart for an operation of a BS for maintaining a DTM during performance of a handover in a GSM system according to an exemplary embodiment of the present invention.

Referring to FIG. 3, in step 300, the BS receives measurement result information (i.e., information of FIG. 4) from a corresponding MS.

In step 302, the BS determines whether a handover of the MS is necessary by considering received signal strength, received signal quality, and the like, among the measurement result information.

If the handover is necessary, the BS recognizes whether the DTM is considered in the measurement result in step 304. For example, referring to the “DTM-IND” field value among the measurement result information of FIG. 4, if DTM-IND=0, the DTM is not considered in the measurement result, as in the conventional method, (i.e., when information indicating whether the DTM is supported does not exist, and information indicating received signal strength, received signal quality, and the like exists). If DTM-IND=1, the DTM is considered in the measurement result (i.e., when information indicating whether the DTM is supported exists, and information indicating received signal strength, received signal quality, and the like exist). If the handover is unnecessary, the procedure proceeds to step 308.

In step 306, the BS recognizes information which indicates a cell supporting the DTM and is reported by the corresponding MS. For example, referring to the “DTM-IS-CELL” field value among the measurement result information of FIG. 4, if DTM-IS-CELL=0, the cell supporting the DTM does not exist. If DTM-IS-CELL=1, the cell supporting the DTM exists. In addition, the DTM-CELLS field value indicates whether the DTM is supported in a bitmap format of ‘1’ and ‘0’. If a bitmap is ‘101101’, the bitmap indicates that 2nd and 5th cells do not support the DTM and 1st, 3rd, 4th and 6th cells support the DTM.

In step 308, the BS determines a target cell to which a handover is performed while maintaining the DTM, and transmits a handover command to the corresponding MS. In this case, by selecting the target cell to perform a handover by using information on a cell supporting the DTM, a DTM service may be seamlessly maintained.

In step 310, the BS performs the handover process on the corresponding MS.

Thereafter, the procedure of FIG. 3 ends.

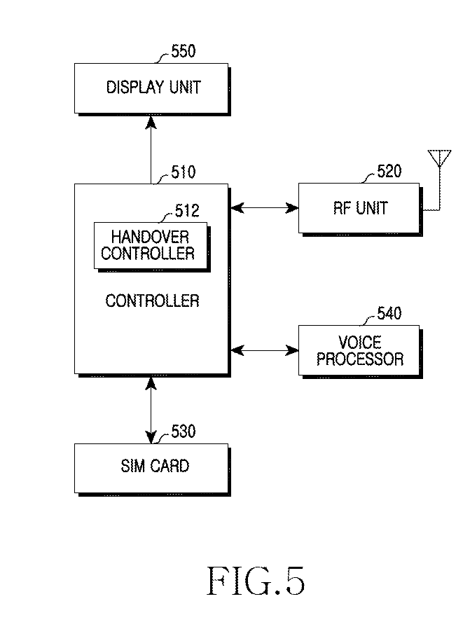

FIG. 5 illustrates a block diagram for a structure of an MS for maintaining a DTM during performance of a handover in a GSM system according to an exemplary embodiment of the present invention.

Referring to FIG. 5, the MS includes a controller 510, a handover controller 512, a Radio Frequency (RF) unit 520, a Subscriber Identity Module (SIM) card 530, a voice processor 540 and a display unit 550.

The controller 510 controls overall operations of the MS and also controls a general communication function. The RF unit 520 converts a received analog signal into a digital signal by performing an amplification operation. The SIM card 530 stores International Mobile Subscriber Identity (IMSI), Short Message Service (SMS) information, and the like. The voice processor 540 demodulates a signal received through an antenna to output a voice signal through a speaker and processes the voice signal input through a microphone to output a digital signal. The display unit 550 displays information, such as state information, which is generated while the MS operates, limited numeral characters, large-sized moving and still pictures, and the like. The display unit 550 may be a color Liquid Crystal Display (LCD).

The RF unit 520 receives broadcast control messages from at least one or more neighbor cells, and provides a result of reception to the controller 510. The controller 510 determines whether the neighboring cells support the DTM by using the broadcast control messages, generates a measurement result including the determination result on whether the DTM is supported, and reports the measurement result.

The broadcast control message includes system information indicating whether the DTM is supported. In order to provide the determination result on whether the DTM is supported, the broadcast control message includes a DTM_IND field indicating whether the measurement result is for the DTM, a DTM-IS_CELL field indicating existence of cells supporting the DTM, and a DTM-CELLS field indicating support or non-support of the DTM with respect to one or more neighbor cells (see FIG. 4 above). The DTM-CELLS field value has a bitmap format.

Meanwhile, the controller 510 determines whether the neighboring cells support the DTM or whether received signal strength satisfies a threshold among the at least one or more neighbor cells. In addition, if the current mode is not the DTM, the determination result on whether the DTM is supported is not included in the measurement result.

After reporting the measurement result, the handover controller 512 performs a handover when necessary.

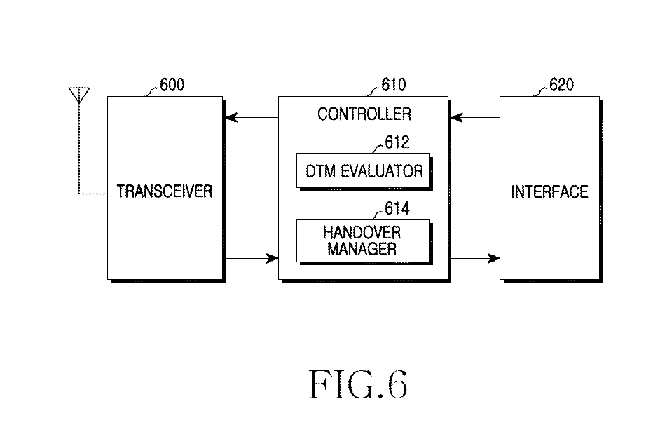

FIG. 6 illustrates a block diagram for a structure of a BS for maintaining a DTM during performance of a handover in a GSM system according to an exemplary embodiment of the present invention.

Referring to FIG. 6, the BS includes a transceiver 600, a controller 610, a DTM evaluator 612, a handover manager 614 and an interface 620. The transceiver 600 converts a received analog signal into a digital signal by performing an amplification operation. Further, the transceiver 600 receives a measurement result from a corresponding MS or transmits a broadcast control message.

The controller 610 controls overall operations of the BS and also controls a general communication function. Further, the controller 610 is coupled to a superordinate network entity (e.g., a switching unit) through the interface 620.

The DTM evaluator 612 determines whether neighbor cells support the DTM by using the measurement result. The handover manager 614 determines a target BS for performing the handover by considering whether the neighbor cells support the DTM. Further, the handover manager 614 performs the handover process when necessary. Information indicating whether the neighbor cells support the DTM has a bitmap format.

According to exemplary embodiments of the present invention, an MS reports whether neighbor cells support the DTM to a BS in a GSM system. Therefore, there is an advantage in that a DTM service may be seamlessly maintained.

Exemplary embodiments of the present invention can also comprise computer readable codes on a computer readable medium. The computer readable medium can comprise any data storage device that can store data that can be read by a computer system. Examples of a computer readable medium include magnetic storage media (such as, ROM, floppy disks, hard disks, among others), optical recording media (such as, CD-ROMs, or DVDs), and storage mechanisms such as carrier waves (such as, transmission through the Internet). The computer readable medium can also be distributed over network coupled computer systems so that the computer readable code is stored and executed in a distributed fashion. Also, functional programs, codes, and code segments for accomplishing exemplary embodiments of the present invention can be construed by programmers of ordinary skill in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for operating a Mobile Station (MS) for maintaining a Dual Transfer Mode (DTM) during performance of a handover in a Global System for Mobile Communications (GSM) system, the method comprising:
receiving a broadcast control message from at least one neighbor cell;
determining whether the at least one neighbor cell supports the DTM by using the broadcast control message; and
reporting the determination result on whether the DTM is supported and a received signal measurement result.

2. The method of claim 1, wherein the broadcast control message comprises system information indicating whether the DTM is supported.

3. The method of claim 1, wherein the broadcast control message comprises at least one of a DTM_IND field indicating whether the measurement result is for the DTM, a DTM-IS_CELL field indicating existence of cells supporting the DTM, and a DTM-CELLS field indicating one of support and non-support of the DTM with respect to the at least one neighbor cell.

4. The method of claim 3, wherein the DTM-CELLS field comprises a value in a bitmap format.

5. The method of claim 1, wherein the determination result based on whether the DTM is supported is determined for neighbor cells of which received signal strength satisfies a threshold among the at least one neighbor cell.

6. The method of claim 1, wherein, if a current mode is not the DTM, the determination result on whether the DTM is supported is not included in the measurement result.

7. The method of claim 1, further comprising, after reporting the measurement result, performing a handover according to the measurement result.

8. A method for operating a Base Station (BS) for maintaining a Dual Transfer Mode (DTM) during performance of a handover in a Global System for Mobile Communications (GSM) system, the method comprising:
receiving information indicating whether the DTM is supported and a measurement result from a corresponding Mobile Station (MS);
determining whether neighbor cells of the corresponding MS support the DTM by using the measurement result; and
determining a target BS for the handover process by considering whether the neighbor cells support the DTM.

9. The method of claim 8, further comprising performing the handover process when a handover of the corresponding MS is necessary.

10. The method of claim 8, wherein the determination result based on whether the neighbor cells support the DTM comprises a bitmap format.

11. A Mobile Station (MS) apparatus for maintaining a Dual Transfer Mode (DTM) during performance of a handover in a Global System for Mobile Communications (GSM) system, the apparatus comprising:
a Radio Frequency (RF) unit for receiving a broadcast control message from at least one neighbor cell; and
a controller for determining whether the at least one neighbor cell supports the DTM by using the broadcast control message, and for reporting the determination result on whether the DTM is supported and a received signal measurement result.

12. The apparatus of claim 11, wherein the broadcast control message comprises system information indicating whether the DTM is supported.

13. The apparatus of claim 11, wherein the broadcast control message comprises at least one of a DTM_IND field indicating whether the measurement result is for the DTM, a DTM-IS_CELL field indicating existence of cells supporting the DTM, and a DTM-CELLS field indicating one of support and non-support of the DTM with respect to the at least one neighbor cell.

14. The apparatus of claim 13, wherein the DTM-CELLS field comprises a value in a bitmap format.

15. The apparatus of claim 11, wherein the determination result based on whether the DTM is supported is determined for neighbor cells of which received signal strength satisfies a threshold among the at least one neighbor cell.

16. The apparatus of claim 11, wherein, if a current mode is not the DTM, the determination result on whether the DTM is supported is not included in the measurement result.

17. The apparatus of claim 11, further comprising a handover controller for performing a handover according to the measurement result, after reporting the measurement result.

18. A Base Station (BS) apparatus for maintaining a Dual Transfer Mode (DTM) during performance of a handover in a Global System for Mobile Communications (GSM) system, the apparatus comprising:
a transmitter for receiving a measurement result from a corresponding Mobile Station (MS);
a DTM evaluator for determining whether neighbor cells support the DTM by using the measurement result; and
a handover manager for determining a target BS for the handover process by considering whether the neighbor cells of the corresponding MS support the DTM.

19. The apparatus of claim 18, wherein the handover manager performs the handover process when a handover of the corresponding MS is necessary.

20. The apparatus of claim 18, wherein the determination result based on whether the neighbor cells support the DTM comprises a bitmap format.

21. A method for operating a Mobile Station (MS) for maintaining a Dual Transfer Mode (DTM) during performance of a handover in a Global System for Mobile Communications (GSM) system, the method comprising:
measuring a received signal strength from at least one neighbor cell;
determining whether the received signal strength satisfies a threshold;
determining whether the at least one neighbor cell of which received signal strength satisfies a threshold, supports the DTM; and
reporting at least one of information for the DTM and the received signal measurement result.

22. The method of claim 21, wherein the information for the DTM comprises at least one of a DTM_IND field indicating whether the measurement result is for the DTM, a DTM-IS_CELL field indicating existence of cells supporting the DTM, and a DTM-CELLS field indicating one of support and non-support of the DTM with respect to the at least one neighbor cell.

23. A computer-readable recording medium having recorded thereon a program for maintaining a Dual Transfer Mode (DTM) during performance of a handover in a Global System for Mobile Communications (GSM) system, comprising:
a first code segment, receiving a broadcast control message from at least one neighbor cell;
a second code segment, determining whether the at least one neighbor cell supports the DTM by using the broadcast control message; and
a third code segment, reporting the determination result on whether the DTM is supported and a received signal measurement result.

24. A computer-readable recording medium having recorded thereon a program for maintaining a Dual Transfer Mode (DTM) during performance of a handover in a Global System for Mobile Communications (GSM) system, comprising:
a first code segment, measuring a received signal strength from at least one neighbor cell;
a second code segment, determining whether the received signal strength satisfies a threshold;
a third code segment, determining whether the at least one neighbor cell of which received signal strength satisfies a threshold, supports the DTM; and
a fourth code segment, reporting at least one of information for the DTM and the received signal measurement result.
